(19) United States
(12) Patent Application Publication
(10) Pub. No.: US 2024/0227244 A1
(43) Pub. Date: Jul. 11, 2024

(54) PROCESS FOR PRODUCING A CURED RUBBER SHEET THAT IS FREE OF SURFACE PARTICULATE

(71) Applicant: Holcim Technology Ltd, Zug (CH)

(72) Inventors: Jiansheng TANG, Westfield, IN (US); Dharamdeep JAIN, Akron, OH (US); Andrew KINNAIRD, Greenwood, IN (US); Brian ALEXANDER, Westfield, IN (US)

(21) Appl. No.: 18/559,209

(22) PCT Filed: May 9, 2022
(86) PCT No.: PCT/US2022/028341

§ 371 Date: Nov. 6, 2023

Related U.S. Application Data
(60) Provisional application No. 63/185,580, filed on May 7, 2021.

(51) Int. Cl. B29B 15/10; B29B 7/90; B29C 35/02; B29K 9/06; C09D 7/40; C09D 175/04

(52) U.S. Cl. CPC B29B 15/10; B29B 7/90; B29C 35/0288; C09D 7/40; C09D 175/04; B29K 2009/06

(57) ABSTRACT

A method for making a cured rubber sheet, the method comprising providing an uncured rubber sheet, where the uncured rubber sheet includes opposing planar surfaces; applying a curable coating composition to at least one planar surface of the uncured rubber sheet to form at least one layer of curable coating composition, where the curable coating composition includes a polymer with a silicon-containing hydrolyzable terminal group polymer; subjecting the curable coating composition to curing conditions that cure the coating composition and thereby form at least one cured coating layer on the uncured rubber sheet, wherein the at least one cured coating layer includes a cured residue of the polymer with a silicon-containing hydrolyzable terminal group polymer; rolling the uncured rubber sheet having at least one cured coating layer onto itself to form a roll; and subjecting the roll to curing conditions that cure the uncured rubber sheet and thereby forms a roll of cured rubber sheet.

This application claims the benefit of U.S. Provisional Application Ser. No. 63/185,580 filed on May 7, 2021, which is incorporated herein by reference.

### FIELD OF THE INVENTION

Embodiments of the present invention are directed toward a process for producing a rubber sheet, such as an EPDM sheet, that is useful as a roofing membrane. The rubber sheet is fabricated by using a process that results in a particulate-free cured sheet.

### BACKGROUND OF THE INVENTION

EPDM membranes, which are cured sheets of ethylene-propylene-diene terpolymer rubber, are often used in the construction industry to cover flat or low-sloped roofs. During manufacture of the EPDM membranes, uncured sheets, also referred to as green membranes, are rolled and placed into a curing oven to effect vulcanization of the rubber in the presence of a cure system. In order to prevent the roll of green membrane from sticking to itself (“blocking”), and ultimately curing to itself, the membrane is treated with a dusting agent or particulate prior to being rolled and cured. Industry standards include the use of talc and mica for dusting, although other materials have been used such as, for example, cellulosic materials. After curing of the membrane, the rolled, cured membrane is unrolled, typically within a stripping operation, and then fabricated into a roofing membrane. Fabrication may include, for example, cutting the membrane to size or applying an adhesive tape.

These membranes, which may also be referred to as panels, are typically delivered to a construction site in a bundled roll, transferred to the roof, and then unrolled and positioned. The sheets are then affixed to the building structure by employing varying techniques such as mechanical fastening, ballasting, and/or adhesively adhering the membrane to the roof. The roof substrate to which the membrane is secured may be one of a variety of materials depending on the installation site and structural concerns. For example, the surface may be a concrete, metal, or wood deck, it may include insulation or recover board, and/or it may include an existing membrane.

In addition to securing the membrane to the roof—which mode of attachment primarily seeks to prevent wind uplift—the individual membrane panels, together with flashing and other accessories, are positioned and adjoined to achieve a waterproof barrier on the roof. Typically, the edges of adjoining panels are overlapped, and these overlapping portions are adjoined to one another through a number of methods depending upon the membrane materials and exterior conditions. The overlapped portions are often referred to as lap regions. One approach to seaming the membranes involves providing adhesives or adhesive tapes between the overlapping portions, thereby creating a water-resistant seal.

Where adhesives are employed to seam the membranes to each other (i.e., create a lap seam) and/or adhere the membrane to the roof surface, the presence of the dusting agent, which may also be referred to as particulate, can be problematic since the dusting agent can interfere with proper adhesion between the membrane and the adhesive. As a result, steps must be taken to remove the dusting agent in the location where the adhesive is applied. For example, known techniques for lap seam preparation include the use of a primer solution in conjunction with a scrubbing apparatus that can lift the dusting agent away from the membrane by, for example, employing scrubbing techniques. Similar issues exist where there is a desire to create a fully-adhered roofing system wherein adhesive is used to secure substantially one surface of a membrane panel to the roof deck. Typically, where there is a desire to create a fully-adhered roofing system, thick layers of adhesive, or multiple layers of adhesive, including those adhesives that are dissolved in organic solvents, are used to adhere the membranes that carry the dusting agent. Still further, the presence of the dusting agent can frustrate further fabrication or modification of the membranes. For example, where there is a desire to adhere a fabric backing to the EPDM sheet, such as a fleece backing, the presence of the dusting agent can frustrate the adherence of the fabric to the membrane. Also, where there is a desire to prepare an EPDM membrane carrying a factory-applied adhesive layer (e.g., a peel-and-stick membrane), the presence of the dusting agent can interfere with proper application and adhesion of the pressure-sensitive adhesive to the membrane surface.

### SUMMARY OF THE INVENTION

One or more embodiments of the present invention provide a method for making a cured rubber sheet, the method comprising (i) providing an uncured rubber sheet, where the uncured rubber sheet includes opposing planar surfaces; (ii) applying a curable coating composition to at least one planar surface of the uncured rubber sheet to form at least one layer of curable coating composition, where the curable coating composition includes a polymer with a silicon-containing hydrolyzable terminal group polymer; (iii) subjecting the curable coating composition to curing conditions that cure the coating composition and thereby form at least one cured coating layer on the uncured rubber sheet, wherein the at least one cured coating layer includes a cured residue of the polymer with a silicon-containing hydrolyzable terminal group polymer; (iv) rolling the uncured rubber sheet having at least one cured coating layer onto itself to form a roll; and (v) subjecting the roll to curing conditions that cure the uncured rubber sheet and thereby forms a roll of cured rubber sheet.

One or more embodiments of the present invention further provide a cured rubber membrane sheet comprising (i) a planar body having first and second planar surfaces, said planar body including cured rubber; and (ii) a cured coating layer disposed on said first planar surface of said planar body, and wherein the cured coating layer includes a cured residue of the polymer with a silicon-containing hydrolyzable terminal group polymer.

### BRIEF DESCRIPTION OF THE DRAWINGS

FIG. 1 is a flow chart showing steps involved in the process of one or more embodiments of the invention.

FIG. 2 is a perspective view of a cured rubber membrane prepared according to one or more embodiments of the present invention.

### DETAILED DESCRIPTION OF ILLUSTRATIVE EMBODIMENTS

Embodiments of the present invention are based, at least in part, on the discovery of a process for producing a cured rubber sheet (e.g., a cured EPDM sheet) that is substantially free of surface particulate. The process includes providing an uncured rubber sheet (e.g., roofing membrane), applying a moisture-curable coating composition to at least one planar surface of the sheet, allowing the moisture-curable coating composition to at least partially cure and thereby form an at least partially-cured coating layer on the uncured rubber sheet, and then curing the uncured rubber sheet while the sheet is rolled on itself. According to embodiments of the invention, the moisture-curable coating composition includes a polymer having a silicon-containing hydrolyzable terminal group. The moisture-curable coating layer creates a boundary layer, which may also be referred to as a barrier layer, which prevents the green membrane from curing to itself or otherwise deleteriously adhering to itself. The ability to form a boundary or barrier layer was unexpected in view of the nature and thickness of the moisture-curable coating layer. The resultant cured membrane can then be unwound and used as a roofing membrane. Advantageously, these roofing membranes can be secured to a roof deck and/or seamed to adjacent membranes without the need to address surface particulate that can interfere with the adhesives. Additionally, because these rubber sheets are substantially free of surface particulate, these rubber sheets can advantageously be modified by, for example, application of a fabric backing or pressure-sensitive adhesive, without taking additional steps or added measures to account for surface particulate. Accordingly, a fleece-backed EPDM sheet or a peel-and-stick EPDM sheet, which carries a layer of pressure-sensitive adhesive, can be prepared using technologically efficient manufacturing techniques.

### Process Description

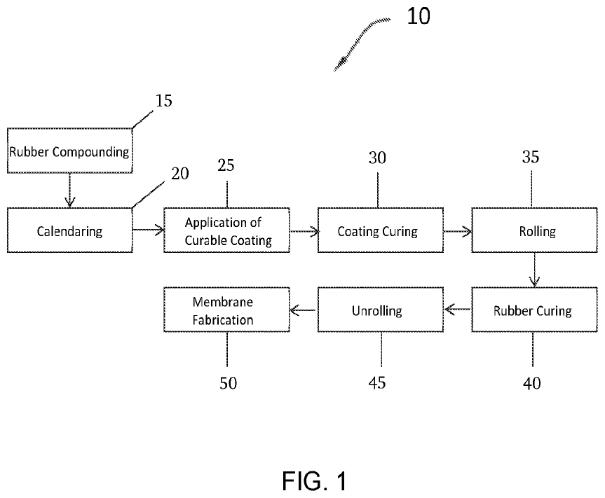

Aspects of the invention can be described with reference to FIG. 1. In one or more embodiments, a process 10 for manufacturing a cured rubber membranes includes a rubber compounding step 15, which generally prepares vulcanizable rubber composition that is capable of being calendared within a subsequent calendaring step 20. Through the calendaring process or step, an uncured rubber sheet is produced. This uncured rubber sheet, which can also be referred to as a green sheet, can be provided to a coating step 25, wherein a layer of moisture-curable coating composition is applied to at least one planar surface of the uncured rubber sheet. As described herein, the moisture-curable coating composition includes a silicon-terminated polymer. Following application of the moisture-curable coating composition, which forms a layer of moisture-curable coating composition on the uncured sheet, the coated membrane (and in particular the moisture-curable coating composition) may optionally subjected to curing conditions or otherwise provided an opportunity to at least partially cure or crosslink within a curing step 30 to form an at least partially cured coating layer. As should be appreciated, the cured coating layer includes the cured residue of the moisture-curable coating composition. Stated another way, the cured coating layer is formed from the moisture-curable coating composition. Following step 30 of curing the moisture-curable coating composition, the membrane is rolled onto itself, which may also be referred to as winding, within a rolling or winding step 35. As the skilled person will appreciate, the membrane is wound in a manner to place the coating between the contacting surfaces of the membrane. This step produces a roll of uncured rubber sheet having disposed on at least one planar surface thereof the layer of cured coating, which forms a boundary or barrier where the membrane would otherwise contact itself in the rolled position. This roll is then subjected to rubber curing conditions within a curing step 40, which serves to cure the uncured rubber sheet and optionally fully cure the coating composition. As a result of curing step 40, a roll of cured rubber sheet is produced, wherein the cured rubber sheet has disposed on at least one planar surface thereof a cured coating layer. The roll of cured rubber sheet is then unwound, which may also be referred to as unrolled, within an unrolling or unwinding step 45. Once unrolled, the cured rubber sheet can be fabricated into a roofing membrane within a fabrication step 50.

### Preparation of Vulcanizable Composition

As indicated above, the membranes of the present invention can be prepared from vulcanizable rubber compositions. In one or more embodiments, these vulcanizable compositions, which may also be referred to as curable rubber compositions, include curable rubber, one or more fillers, and an extender. Additionally, these compositions, which may produce black or non-black membranes, may include other constituents that are employed in rubber membranes or rubber compounds. For example, the compositions may include oil, wax, antioxidant, antiozonant, flame retardant, and the like. Once cured, the cured membranes are a cured network deriving from a vulcanizable rubber composition and optionally the residue or reaction product of the cure system. The various other ingredients may be dispersed throughout the cured network. The membrane may further comprise fabric reinforcement.

In one or more embodiments, the cured rubber derives from a crosslinkable rubber. In one or more embodiments, the cured rubber derives from an olefinic rubber such as an olefinic terpolymer. In one or more embodiments, the olefinic terpolymer includes mer units that derive from ethylene, α-olefin, and optionally diene monomer. Useful α-olefins include propylene. In one or more embodiments, the diene monomer may include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene, and mixtures thereof. Olefinic terpolymers and methods for their manufacture are known as disclosed at U.S. Pat. No. 3,280,082 as well as U.S. Publication No. 2006/0280892, both of which are incorporated herein by reference. Furthermore, olefinic terpolymers and methods for their manufacture are known as disclosed in U.S. Pat. Nos. 8,367,760, 9,915,069, and U.S. Publication No. 2012/0045953, which are also incorporated herein by reference. For purposes of this specification, elastomeric terpolymers may simply be referred to as EPDM.

In one or more embodiments, the elastomeric terpolymer may include at least 62 weight percent, and in other embodiments at least 64 weight percent mer units deriving from ethylene; in these or other embodiments, the elastomeric terpolymer may include at most 70 weight percent, and in other embodiments at most 69 weight percent, mer units deriving from ethylene. In one or more embodiments, the elastomeric terpolymer may include at least 2 weight percent, in other embodiments at least 2.4 weight percent, mer units deriving from diene monomer; in these or other embodiments, the elastomeric terpolymer may include at most 4 weight percent, and in other embodiments at most 3.2 weight percent, mer units deriving from diene monomer. In one or more embodiments, the balance of the mer units derive from propylene or other α-olefins. In one or more embodiments, low Mooney EPDM terpolymers are blended with high Mooney EPDM terpolymers to reduce the overall viscosity of the membrane compound and thereby accommodate processing.

As is known in the art, the rubber may be cured with a curative or cure system. The rubber can be cured by using numerous techniques such as those that employ sulfur cure systems, peroxide cure systems, and quinine-type cure systems. In certain embodiments, the sulfur cure systems may be employed in combination with vulcanizing accelerators. Suitable vulcanizing accelerators are disclosed in U.S. Publication No. 2006/0280892, which is incorporated herein by reference. Examples of organic polysulfides are disclosed in U.S. Pat. No. 2,619,481, which is incorporated herein by reference.

Sulfur and sulfur-containing cure systems may be used and may also be used with an accelerator. Suitable amounts of sulfur can be readily determined by those skilled in the art. In one or more embodiments from about 0.25 to 3.0 parts by weight (pbw) sulfur per 100 parts by weight rubber (phr) may be used, in other embodiments from about 0.30 to 2.8 pbw sulfur phr, and in other embodiments from about 0.35 to 2.5 pbw sulfur phr. The amount of accelerator can also be readily determined by those skilled in the art. In one or more embodiments, from about 1.5 to about 10 pbw accelerator phr may be used, in other embodiments from about 2.0 to about 9 pbw accelerator phr may be used, in other embodiments from about 2.5 to about 8 pbw accelerator phr may be used, and in yet other embodiments from about 3.0 to about 7 pbw accelerator phr may be used.

As mentioned above, the compositions and resulting membranes may include filler. These fillers may include those conventionally employed in the art, as well as combinations of two or more of these fillers. In one or more embodiments, the filler may include carbon black. Examples of useful carbon blacks include those generally characterized by average industry-wide target values established in ASTM D-1765. Exemplary carbon blacks include GPF (General-Purpose Furnace), FEF (Fast Extrusion Furnace), and SRF (Semi-Reinforcing Furnace). One particular example of a carbon black is N650 GPF Black, which is a petroleum-derived reinforcing carbon black having an average particle size of about 60 nm and a specific gravity of about 1.8 g/cc. Another example is N330, which is a high abrasion furnace black having an average particle size about 30 nm, a maximum ash content of about 0.75%, and a specific gravity of about 1.8 g/cc.

Other useful fillers include clay and talc, such as those disclosed in U.S. Publication No. 2006/0280892, which is incorporated herein by reference. Still other useful fillers include silica, which may be used in conjunction with a coupling agent. U.S. Pat. No. 8,367,760 discloses useful fillers including silica and is incorporated herein by reference.

As mentioned above, the compositions and resulting membranes may include extenders. Useful extenders include paraffinic, naphthenic oils, and mixtures thereof. These oils may be halogenated as disclosed in U.S. Pat. No. 6,632,509, which is incorporated herein by reference. In one or more embodiments, useful oils are generally characterized by low surface content, low aromaticity, low volatility, and a flash point of more than about 550° F. Useful extenders are commercially available. One particular extender is a paraffinic oil available under the tradename SUNPAR™ 2280 (Sun Oil Company). Another useful paraffinic process oil is HYPRENE P150BS (Ergon Oil Inc. of Jackson, MS).

In addition to the foregoing constituents, the compositions and resulting membranes may also optionally include mica, coal filler, ground rubber, titanium dioxide, calcium carbonate, silica, homogenizing agents, phenolic resins, flame retardants, zinc oxide, stearic acid, and mixtures thereof as disclosed in U.S. Publication No. 2006/0280892. Certain embodiments may be substantially devoid of any of these constituents.

In one or more embodiments, the compositions and resulting rubber membranes may include from about 20 to about 50, in other embodiments from about 24 to about 36, and in other embodiments from about 28 to about 32% by weight rubber (e.g., EPDM) based on the entire weight of the mixture.

In one or more embodiments, the compositions and resulting rubber membranes may include from about 70 to about 100 pbw, in other embodiments from about 75 to about 95 pbw, and in other embodiments from about 77 to about 85 parts by weight carbon black phr. Certain embodiments may be substantially devoid of carbon black.

In one or more embodiments, the compositions and resulting rubber membranes may include from about 55 to about 95 pbw, in other embodiments from about 60 to about 85 pbw, and in other embodiments from about 65 to about 80 pbw extender per 100 pbw phr.

The various ingredients can be mixed together using conventional rubber mixing techniques, which are well known in the art. These techniques include both batch and continuous mixing. In this regard, U.S. Publication Nos. 2021/0308927, 2019/0047199, 2018/0179759, 2016/0312471, 2016/0002929, and 2014/0373467 are incorporated herein by reference.

### Calendaring

In one or more embodiments, the step of calendaring the vulcanizable composition to form an uncured rubber sheet may employ conventional calendaring techniques. As is generally known in the art, the step of calendaring produces an uncured rubber sheet having a thickness generally similar to the thickness of the desired product (i.e., the cured rubber sheet).

In one or more embodiments, the thickness of the uncured rubber sheet may be at least 15 mil (0.381 mm), in other embodiments at least 40 mil (1.016 mm), and in other embodiments at least 60 mil (1.524 mm). In these or other embodiments, the thickness of the uncured rubber sheet may be at most 120 mil (3.048 mm), in other embodiments at most 100 mil (2.54 mm), and in other embodiments at most 80 mil (2.032 mm). In one or more embodiments, the thickness of the uncured rubber sheet may be from about 30 mil (0.762 mm) to about 120 mil (3.048 mm), in other embodiments from about 40 mil (1.016 mm) to about 100 mil (2.54 mm), and in other embodiments from about 45 mil (1.143 mm) to about 90 mil (2.286 mm).

### Application of Curable Coating

As indicated above, the uncured rubber sheet, which includes first and second opposing planar surfaces, receives a coating of the moisture-curable coating composition on at least one of its planar surfaces. Application of the moisture-curable coating composition to at least one planar surface of the uncured sheet forms a moisture-curable coating layer, which may also be referred to as a layer of moisture-curable coating composition on the planar surface of the uncured sheet. In particular embodiments, the coating composition is applied to only one planar surface of the sheet. In other embodiments, the coating composition is applied to both planar surfaces of the sheet.

In one or more embodiments, the thickness of the moisture-curable coating layer disposed on at least one planar surface (or to both surfaces) of the uncured sheet may be greater than 80 μm, in other embodiments greater than 90 μm, in other embodiments greater than 100 μm, in other embodiments greater than 110 μm, in other embodiments greater than 120 μm, in other embodiments greater than 130 μm, and in other embodiments greater than 140 μm. In these or other embodiments, the thickness of the moisture-curable coating layer may be less than 300 μm, in other embodiments less than 280 μm, in other embodiments less than 260 μm, in other embodiments less than 240 μm, and in other embodiments less than 220 μm. In one or more embodiments, the thickness of the moisture-curable coating layer may be from about 80 to about 300 μm, in other embodiments from about 90 to about 280 μm, and in other embodiments from about 100 to about 260 μm.

The moisture-curable coating composition may be applied to at least one planar surface of the uncured sheet using a variety of techniques. In one or more embodiments, the moisture-curable coating composition is applied to at least one planar surface of the uncured sheet using spraying techniques. In other embodiments, the moisture-curable coating composition is disposed on at least one planar surface of an uncured sheet using knife-coating techniques. In other embodiments, a curtain coater may be employed.

In one or more embodiments, the moisture-curable coating composition is applied over substantially the entire planar surface of the uncured sheet. In these or other embodiments, the moisture-curable coating layer formed by application of the coating composition to the uncured sheet is continuous. In one or more embodiments, the moisture-curable coating layer covers at least 80%, in other embodiments at least 85%, in other embodiments at least 90%, and in other embodiments at least 99% of the surface area of one planar surface of the uncured sheet. In one or more embodiments, the moisture-curable composition is applied to only one planar surface of the sheet. In other embodiments, the moisture-curable composition is applied to both planar surfaces of the sheet.

In particular embodiments, the moisture-curable coating composition is not applied to specific areas of the planar surface of the uncured sheet. For example, the planar surface of the uncured sheet may include a region generally known as the lap region, which is the area wherein the final product will overlap with adjoining sheets in a roof construction. These lap regions generally extend along the length of the membrane adjacent to the lateral edge of the membrane; i.e., the edge running along the length of the membrane. In one or more embodiments, the membrane may include one lap edge, and in other embodiments the membrane may include two lap edges, one on each opposing lateral side of the membrane.

In one or more embodiments, the step of applying the curable coating composition to at least one planar surface of the membrane excludes application of the moisture-curable coating composition to one or more lap regions. In these or other embodiments, the layer of moisture-curable coating composition may nonetheless be continuous between the lap regions. In other embodiments, the coating is applied over the entire sheet even in the lap regions.

### Allowing and Promoting Cure

In one or more embodiments, once the moisture-curable coating composition is applied to a surface of the membrane, sufficient time may optionally be provided to at least partially cure the membrane before advancing the membrane to the next step in the process. Also, in one or more embodiments, the coated membrane may optionally be subjected to an environment that expedites or otherwise facilities cure. This may include, but is not limited to, environments with high moisture and/or elevated temperatures.

In one or more embodiments, the coated membrane may be provided greater than 10 seconds, in other embodiments greater than 30 seconds, in other embodiments greater than 1.0 minutes, in other embodiments greater than 2 minutes, and in other embodiments greater than 5 minutes before subjecting the coated membrane to the next step in the process (e.g. winding). In one or more embodiments, the coated membrane may be provided from about 10 seconds to about an hour, in other embodiments from about 30 seconds to about 45 minutes, in other embodiments from about 1.0 minutes to about 30 minutes, and in other embodiments from about 2 minutes to about 15 minutes before subjecting the coated membrane to the next step in the process (e.g. winding).

In one or more embodiments, the coated membrane may be subjected to an environment with greater than 50%, in other embodiments greater than 60%, in other embodiments greater than 80%, and in other embodiments greater than 100% relative humidity in order to advance curing of the coating composition.

In one or more embodiments, the coated membrane may be subjected to an environment with a temperature of greater than 22° C., in other embodiments greater than 25° C., in other embodiments greater than 30° C., and in other embodiments greater than 40° C. in order to advance curing of the coating composition.

In one or more embodiments, the coating composition is allowed to achieve threshold curing before advancing the coated membrane to the next steps in the process. In one or more embodiments, the moisture-curable coating composition is greater than 30%, in other embodiments greater than 40%, in other embodiments greater than 50% cured, in other embodiments at least 60% cured, and in other embodiments at least 70% cured before advancing the membrane to the next steps in the process.

In one or more embodiments, the threshold curing of the coating composition, which may desirably be achieved before advancing the coated membrane to the next step of the process, may be qualitatively described as no tack to the touch. In other words, the coating is cured to the extent that a skin forms over the coating composition that allows the composition to be touched under moderate pressure without bonding.

### Rolling and Curing

In one or more embodiments, once the moisture-curable coating composition has been applied to the membrane, optionally provided sufficient time to achieve a desirable level of cure, and optionally has been subjected to curing conditions to thereby form an at least partially cured coating on the uncured rubber sheet, the coated membrane is rolled onto itself. As the skilled person appreciates, the uncured membrane is wound into a roll for convenient placement into a curing apparatus. The skilled person will also appreciate that as the uncured membrane, which carries the cured coating layer, is wound upon itself, the at least partially cured coating layer will contact the planar surface of the uncured rubber sheet that is opposite to the planar surface upon which the coating composition was deposited.

The rolled membrane is then subjected to curing conditions that will cure the uncured rubber. In one or more embodiments, these curing conditions include subjecting the membrane to elevated temperatures. For example, the uncured rubber sheet, which carries the cured coating layer, may be subjected to temperatures in excess of 120° C., in other embodiments in excess of 130° C., and in other embodiments in excess of 150° C. In these or other embodiments, the membranes may be subjected to temperatures of from about 120° C. to about 200° C., in other embodiments from about 130° C. to about 180° C., and in other embodiments from about 140° C. to about 160° C. In these or other embodiments, the membranes may also be subjected to elevated pressures.

In one or more embodiments, curing may take place within an oven. In these or other embodiments, curing may take place within a rubber curing autoclave.

In one or more embodiments, the uncured rubber sheet, particularly in the form of a roll, is subjected to curing conditions (e.g., elevated temperatures) for at least 1 hour, in other embodiments at least 3 hours, and in other embodiments at least 6 hours. In these or other embodiments, the uncured rubber sheet, particularly in the form of a roll, is subjected to cuing conditions for about 1 to about 24 hours, in other embodiments for about 3 to about 20 hours, and in other embodiments for about 6 to about 18 hours.

### Unwinding and Fabrication

In one or more embodiments, the step of subjecting the uncured rubber sheet to curing conditions produces a cured rubber sheet carrying the cured coating layer. Where the uncured rubber sheet is wound into a roll prior to curing, the cured rubber sheet is then unwound following the curing step. The step of unwinding the cured rubber sheet can take place by using conventional techniques. For example, those skilled in the art are familiar with a stripping operation whereby the cured rubber sheet is unwound using an apparatus that can supply sufficient pulling force to unwind the membrane. Following the unwinding of the membrane, the membrane can be subjected to subsequent fabrication steps.

In one or more embodiments, the cured membrane, when in the form of a roll wherein the cured coating composition contacts the opposite planar surface of the membrane to which the coating was originally disposed, is characterized by technologically useful adhesion (or lack thereof) between the cured coating composition and the opposite planar surface of the membrane. In other words, any adhesion that exists between the surface of the cured coating and the opposite planar surface that the cured coating contacts when in the form of a roll is sufficiently weak to allow the rolled membrane to be efficiently unrolled. The level of adhesion that may exist between the top surface of the cured coating layer and the opposite planar surface of the cured membrane, which two surfaces contact each other when in the form of a roll, may be quantitatively defined based upon the pull force required to pull apart a similar assembly. For example, a test specimen may be prepared by applying a curable coating composition to a sample of uncured rubber sheet. The coating composition is then subsequently cured. A second uncured rubber sheet is then applied to the cured coating composition to form a sandwich wherein the cured coating composition is disposed between two uncured rubber sheets, and the sandwich sample is then subjected to curing conditions to cure the rubber such as 320° F. for 45 minutes under sufficient pressure to remove any entrapped air. Following the curing step, the respective cured rubber sheets are placed within opposing grips of an Instron and pulled apart. The pull force is accordingly measured. In one or more embodiments, the pull force required to pull the second cured rubber sheet from the surface of the cured coating is less than 15 lbf/linear inch, in other embodiments less than 10 lbf/linear inch, in other embodiments less than 5 lbf/linear inch, in other embodiments less than 2 lbf/linear inch, and in other embodiments less than 1 lbf/linear inch.

Following the step of curing and optionally unwinding the membrane, the cured membrane may optionally be subjected to one or more additional processing steps prior to storage and/or shipping. In one or more embodiments, the cured membrane may be cut to length to form roofing membranes for installation at a roofing installation site. In the same or other embodiments, the cut membranes may be rolled for storage and shipping. In certain embodiments, the cured membrane may be spliced with other cured membranes to form a larger membrane.

In one or more embodiments, a thin film such as, for example, a primer and/or adhesive, may optionally be applied to one or more surfaces and/or longitudinal edges of the cured membrane prior to the steps of cutting and/or rolling. For example, in certain embodiments, a thin film of adhesive may be applied to substantially all of one surface of the membrane for a fully-adhered roofing system, as will be understood by those skilled in the art. In other embodiments, a thin film of primer and/or adhesive may be applied in a narrow strip along one or more longitudinal edges of the membrane to facilitate the creation of lap seams. A release liner may optionally be positioned over the primer or adhesive layer.

In particular embodiments, a pressure-sensitive adhesive composition or layer is formed on one of the at least one surface of the membrane treated with the coating composition. In other words, after the membrane is cured and the roll of membrane undergoes stripping, a pressure-sensitive adhesive layer is formed on one surface of the membrane carrying the coating composition. Conventional pressure-sensitive adhesive may be used including those disclosed in U.S. Publication Nos. 2004/0157074, 2004/0191508, and 2010/0279049, which are incorporated herein by reference. In particular embodiments, the layer of pressure-sensitive adhesive is formed from hot-melt applied polyacrylate composition that is subsequently cured by, for example, UV energy. In this regard, U.S. Publication Nos. 2016/0230392, 2017/0114543, 2021/0262233, 2017/0015083, and 2018/0355616 are incorporated herein by reference.

### Moisture-Curable Coating Composition

In one or more embodiments, the moisture-curable coating composition contains components that react in the presence of atmospheric moisture to form a cured or cross-linked coating composition. In other words, aspects of the invention may be described with reference to the uncured coating composition, which refers to the composition including constituents of the composition before appreciable chemical reaction or crosslinking takes places. Those skilled in the art will appreciate that aspects of invention can also be described with reference to the cured coating composition, as described elsewhere herein, which refers to the coating after chemical reaction or crosslinking. The cured coating composition includes the cured or crosslinked residue of a moisture-curable coating composition.

### Moisture-Curable Composition Ingredients

Aspects of the invention can be described with reference to the constituents (i.e. ingredients) in the moisture-curable coating composition (i.e. the constituents of the uncured coating composition). In one or more embodiments, the uncured coating compositions include a polymer having silicon-containing hydrolyzable terminal group. In addition, the uncured coating compositions may include a plasticizer, a moisture scavenger, an adhesion promoter, and a catalyst. Other optional ingredients may also be included such as, but not limited to, an antioxidant, a stabilizer, a tackifier, a filler, a crosslink inhibitor (also known as a retarder), a thixotropic compound, and/or an antidegradant. While the compositions of one or more embodiments may include these additional, optional ingredients, embodiments of the invention are also directed toward those compositions that are devoid, or substantially devoid, of one or more of these ingredients.

### Silicon-Terminated Polymers

The polymers having a silicon-containing hydrolyzable terminal group may be referred to as silicon-terminated polymers, silane-terminated polymers, or silyl-terminated polymers. The term “silicon-containing hydrolyzable terminal group” refers to a group wherein at least one silicon atom is associated with a hydrolyzable group, such as a hydrocarbyloxy group (e.g., methoxy or ethoxy group), and is subject to hydrolysis and polymerization through interaction with water (i.e., moisture). In one or more embodiments, the polymer is telechelic, which refers to the fact that the polymer is linear and includes a silicon-containing hydrolyzable terminal group at each end of the polymer chain. In one or more embodiments, the silyl terminal end includes at least two, and in other embodiments at least three hydrolyzable groups (e.g., the hydrolyzable group is a trimethoxy or triethoxy silyl group).

In one or more embodiments, the backbone of the silyl-terminated polymer includes one or more silicon-containing repeat units (e.g., a polysiloxy backbone). In other embodiments, the backbone of the silyl-terminated polymer is devoid of silicon-containing internal repeat units (e.g., a non-siloxy backbone). In one or more embodiments, the backbone of the silyl-terminated polymer includes a polyether, polyesters, polyurethanes (SPUR), or the like.

Suitable polymers having silicon-containing hydrolyzable terminal groups are commercially available and/or can be prepared in accordance with techniques known in the art. Examples of suitable commercially available polymers having silicon-containing hydrolyzable terminal groups are Geniosil™ STP-E 35, which is believed to be a trimethoxysilylpropyl-carbamate-terminated polyether, and Geniosil™ STP-E 30, which is believed to be a silane-terminated polyether with dimethoxy(methyl)silyl methylcarbamate terminal groups, both of which are available from Wacker Chemical. Another commercially available polymer having silicon-containing hydrolyzable terminal groups include “SPUR+” silane-terminated polyurethanes, which are available from Momentive. Another suitable commercially available polymer is “MS” silyl-terminated polyether (S227H, S303, S327, S303H, SAX350), which are available from Kaneka.

### Molecular Weight of Silyl-Terminated Polymers

In one or more embodiments, the silyl-terminated polymers have a number average molecular weight greater than 500 g/mole, in other embodiments greater than 1,000 g/mole, in other embodiments greater than 2,500 g/mole, and in another embodiment greater than 5,000 g/mole. In these or other embodiments, the silyl-terminated polymers have a number average molecular weight of less than 30,000 g/mole, in other embodiments less than 20,000 g/mole, in other embodiments less than 15,000 g/mole, in other embodiments less than 10,000 g/mole, in other embodiments less than 7,000 g/mole, in other embodiments less than 5,000 g/mole, in other embodiments less than 4,000 g/mole, and in other embodiments less than 3,000 g/mole. In one or more embodiments, the silyl-terminated polymers have a number average molecular weight of from about 500 to 30,000, in other embodiments from about 1,000 to about 15,000, and in other embodiments from about 1,500 to about 7,000 g/mole. In these or other embodiments, the silyl-terminated polymers are characterized by a polydispersity of from about 1.0 to about 5.0, in other embodiments from about 1.2 to about 3.5, and in other embodiments from about 1.3 to about 2.5.

In one or more embodiments, the silyl-terminated polymers are characterized by a Brookfield Viscosity, which can be determined by ASTM D789 or D4878 using a #2 spindle at 20 r.p.m. at 20° C. and 50% relative humidity. In one or more embodiments, the Brookfield Viscosity (#2 spindle at 20 r.p.m.) of the silyl terminated polymers is greater than 1000, in other embodiments greater than 1500, and in other embodiments greater than 2000 centipoise. In these or other embodiments, the of the Brookfield Viscosity (#2 spindle at 20 r.p.m.) of the curable sealant compositions is less than 10,000, in other embodiments less than 7,500, in other embodiments less than 6,000, in other embodiments less than 5,000, in other embodiments less than 4,000, in other embodiments less than 3,000, in other embodiments less than 2,500, and in other embodiments less than 1000 centipoise. In one or more embodiments, the Brookfield Viscosity (#2 spindle at 20 r.p.m.) of the curable sealant compositions is from about 1000 to about 10,000, in other embodiments from about 1500 to about 5000, and in other embodiments from about 1700 to about 3000 centipoise.

### Plasticizers

As indicated above, the moisture-curable coating compositions may optionally include a plasticizer. In one or more embodiments, examples of a plasticizer include phthalic acid esters (such as dioctyl phthalate, diisooctyl phthalate, dibutyl phthalate, diundecyl phthalate, diisononyl phthalate, diisodecyl phthalate, diisodocecyl phthalate and butylbenzyl phthalate); aliphatic dibasic acid esters (such as dioctyl adipate, isodecyl succinate, and dibutyl sebacate); glycol esters (such as diethylene glycol dibenzoate and pentaerythritol ester); aliphatic esters (such as butyl oleate and methyl acetylricinoleate); phosphoric acid esters (such as tricresyl phosphate, trioctyl phosphate, and octyldiphenyl phosphate); epoxy plasticizers (such as epoxidated soybean oil, epoxidated linseed oil, and benzyl epoxystearate); polyester plasticizers (such as polyesters of dibasic acid and a divalent alcohol); polyethers (such as polypropylene glycol and its derivatives); polystyrenes (such as poly-α-methylstyrene and polystyrene); polybutadiene butadiene-acrylonitrile copolymer; polychloroprene; polyisoprene; polybutene; chlorinated paraffins; benzoic esters; glycol esters; phosphoric esters; sulfonic esters; and mixtures thereof, wherein any given compound is different than an ingredient otherwise included in the composition of the invention.

In addition, high-molecular weight plasticizers can also be used. Specific examples of such high-molecular weight plasticizer include, but are not limited to, vinyl polymers obtainable by polymerizing a vinyl monomer by various methods; polyalkylene glycol esters such as diethylene glycol dibenzoate, triethylene glycol dibenzoate and pentaerythritol esters; polyester plasticizers obtainable from a dibasic acid, such as sebacic acid, adipic acid, azelaic acid or phthalic acid, and a dihydric alcohol, such as ethylene glycol, diethylene glycol, triethylene glycol, propylene glycol or dipropylene glycol; polyethers such as polyether polyols, e.g. polyethylene glycol, polypropylene glycol and polytetramethylene glycol that have a molecular weight of 500 or more, and even further 1,000 or more, and derivatives of these as obtainable by converting the hydroxyl groups of these polyether polyols to an ester, ether or the like groups; polystyrenes such as polystyrene and poly-α-methylstyrene; polybutadiene, polybutene, polyisobutylene, butadiene-acrylonitrile, polychloroprene and the like. In one or more specific embodiments, plasticizers include propylene glycol dibenzoate, diisononyl phthalate, and soy methyl esters, Mesamol II, HB-40, butylbenzylphthalate. In other specific embodiments, the plasticizers employed are phthalic acid esters. In one or more embodiments, the plasticizers may include high boiling solvents that promote tackification, lowering of viscosity, and sprayability.

In one or more embodiments, the plasticizer is a non-phthalic plasticizer. In one or more embodiments, the plasticizer is a glycol ether ester. In one or more embodiments, glycol ether esters may be prepared from glycol ethers, for example by reaction with carboxylic acids, carboxylic acid chlorides, anhydrides, and inorganic acids. In one or more embodiments, the plasticizer may be prepared by reacting a glycol ether and a carboxylic acid. In one or more embodiments, the glycol ether may be represented by the formula R′OH, and the carboxylic acid may be represented by the formula R″COOH, where R′ is a monovalent organic group that includes at least one ether linkage, and R″ is a monovalent organic group.

Examples of carboxylic acids include formic acid, acetic acid, propionic acid, butyric acid, benzoic acid, pentanoic acid, hexanoic acid, heptanoic acid, octanoic acid, nonanoic acid, decanoic acid, diacids including butanedioic acid, pentanedioic acid, hexanedioic acid, heptanedioic acid, octanedioic acid, nonanedioic acid, and decanedioic acid, and combinations and isomers thereof.

Glycol ethers include alkyl ethers of ethylene glycol or propylene glycol. In one or more embodiments, glycol ethers may be prepared by reacting an alcohol (e.g., methanol, ethanol, propanol, butanol, or hexanol) with ethylene oxide or propylene oxide. Glycol ethers are sometimes classified as e-series and p-series glycol ethers, where the “e” and “p” indicate that the glycol ether was derived from ethylene oxide or propylene oxide, respectively.

Examples of glycol ethers include 2-methoxyethanol (also known as ethylene glycol monomethyl ether, with a chemical formula of CH₃OCH₂CH₂OH), 2-ethoxyethanol (also known as ethylene glycol monoethyl ether, with a chemical formula of CH₃CH₂OCH₂CH₂OH), 2-propoxyethanol (also known as ethylene glycol monopropyl ether, with a chemical formula of CH₃CH₂CH₂OCH₂CH₂OH), 2-isopropoxyethanol (also known as ethylene glycol monoisopropyl ether, with a chemical formula of (CH₃)₂CHOCH₂CH₂OH), 2-butoxyethanol (also known as ethylene glycol monobutyl ether, with a chemical formula of CH₃CH₂CH₂CH₂OCH₂CH₂OH), 2-phenoxyethanol (also known as ethylene glycol monophenyl ether, with a chemical formula of C₆H₅OCH₂CH₂OH), 2-benzyloxyethanol (also known as ethylene glycol monobenzyl ether, with a chemical formula of C₆H₅CH₂OCH₂CH₂OH), 1-methoxy-2-propanol (also known as propylene glycol methyl ether, with a chemical formula of CH₃OCH₂CH(OH)CH₃), 2-(2-methoxyethoxy)ethanol (also known as diethylene glycol monomethyl ether or methyl carbitol, with a chemical formula of CH₃OCH₂CH₂OCH₂CH₂OH), 2-(2-ethoxyethoxy)ethanol (also known as diethylene glycol monoethyl ether or carbitol cellosolve, with a chemical formula of CH₃CH₂OCH₂CH₂OCH₂CH₂OH), 2-(2-butoxyethoxy)ethanol (also known as diethylene glycol mono-n-butyl ether or butyl carbitol, with a chemical formula of CH₃CH₂CH₂CH₂OCH₂CH₂OCH₂CH₂OH), dipropyleneglycol methyl ether, and combinations, complexes, and isomers thereof. In one or more embodiments, the glycol ether is bis[2-(2-butoxyethoxy)ethoxy]methane.

Examples of non-phthalic plasticizers also include methyl cellosolve acetate, ethyl cellosolve acetate, methyl carbitol acetate, ethyl carbitol acetate, ethylene glycol ethyl ether acetate, propylene glycol methyl ether acetate, 3-methyl-3-methoxybutylacetate, diethylene glycol diacetate, dipropylene glycol dibutyrate, hexylene glycol diacetate, glycol diacetate, methyl glycol acetate, ethyl glycol acetate, butyl glycol acetate, ethyl diglycol acetate, butyl diglycol acetate, diethylene glycol dibenzoate, triethylene glycol dibenzoate, and ethyl-3-ethoxypropionate.

In one or more embodiments, the non-phthalic plasticizer may include a glycol ether. Useful glycol ethers include those describe above with reference to the glycol esters. In this regard, the discussion above with respect to glycol ethers is incorporated herein.

In one or more embodiments, the non-phthalic plasticizer may be characterized by a weight average molecular weight of greater than 100, in other embodiments, greater than 110, in other embodiments, greater than 120. In one or more embodiments, non-phthalic plasticizer may be characterized by a weight average molecular weight of less than 1000, in other embodiments, less than 900, in other embodiments, less than 800. In one or more embodiments, non-phthalic plasticizer may be characterized by a weight average molecular weight of from about 100 to about 1000, in other embodiments, from about 110 to about 900, in other embodiments, from about 120 to about 800.

In one or more embodiments, the non-phthalic plasticizer is a liquid at room temperature and at standard pressure, and may be characterized by a boiling point of greater than 100° F., in other embodiments, greater than 150° F., in other embodiments, greater than 200° F. In one or more embodiments, non-phthalic plasticizer may be characterized by a boiling point of less than 600° F., in other embodiments, less than 550° F., in other embodiments, less than 500° F. In one or more embodiments, non-phthalic plasticizer may be characterized by a boiling point of from about 100 to about 600° F., in other embodiments, from about 150 to about 550, in other embodiments, from about 200 to about 500, all of the above measured at atmospheric pressure.

Non-phthalic plasticizers are commercially available, for example from Hallstar Industrial under the trade name Plasthall 190. Advantageously, phthalate plasticizers, which include phthalic acid esters such as dioctyl phthalate, diisooctyl phthalate, dibutyl phthalate, diundecyl phthalate, diisononyl phthalate, diisodecyl phthalate, diisodocecyl phthalate and butylbenzyl phthalate, may be reduced or eliminated from the adhesive composition.

### Moisture Scavenger

In one or more embodiments, a moisture scavenger is optionally included in the coating compositions of this invention. Moisture scavengers that may be employed include chemical moisture scavengers and physical moisture scavengers that absorb and/or adsorb moisture. Examples of chemical moisture scavengers include vinyl-trimethoxysilane. An example of a physical moisture scavenger that may be employed is 3 A Sieves from UOP, which is a zeolite having 3 Angstrom pores capable of trapping moisture. Other examples of moisture scavengers include oxazoladines and calcium oxide.

In one or more embodiments, a low VOC-generating moisture scavenger may be employed within the coating compositions of the present invention. In one or more embodiments, these moisture scavengers are silanes including at least one organo functional group and at least one hydrolyzable group that, upon hydrolysis, generates a non-volatile organic compound or low vapor volatile organic compound (e.g., a glycol or other polyhydric alcohol of relatively high boiling point and/or low vapor pressure). Useful moisture scavenger compounds are described in U.S. Pat. No. 8,088,940, which is incorporated herein by reference.

In one or more embodiments, the moisture scavengers can be defined by the formula

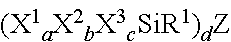

where each occurrence of R¹ is independently a chemical bond between a silicon atom and a carbon atom of the Z group; a hydrocarbyl group of 1 to 10 carbon atoms; or a heterocarbyl of 1 to 10 carbon atoms and at least one heteroatom of nitrogen or oxygen; each occurrence of X¹ is a monovalent alkyl or aryl group of from 1 to 6 carbon atoms or a monovalent heterocarbyl group of from 2 to 8 carbon atoms and at least two heteroatom selected from the group consisting of oxygen and nitrogen, with the proviso that one heteroatom is bonded to a carbon atom of the heterocarbyl group and to the silicon atom; each occurrence of X² is a divalent heterocarbyl group of from 2 to 8 carbon atoms and at least two heteroatoms selected from the group consisting of oxygen and nitrogen, with the proviso that two heteroatoms are bonded to two different carbon atoms of the heterocarbyl group and to the same silicon atom; each occurrence of X³ is a trivalent heterocarbyl group of from about 3 to 8 carbons and at least three heteroatoms selected from the group consisting of oxygen and nitrogen, with the proviso that three heteroatoms are bonded to three different carbon atoms of the heterocarbyl group and to the same silicon atom; each Z is a monovalent or polyvalent organofunctional group of valence d selected from the group consisting of hydrogen, amino, carbamato, epoxy, ureido and alkenyl groups, provided, where Z does not possess a carbon atom, R¹ cannot be a chemical bond; and, each occurrence of a, b, c and d are integers, wherein a is 0 to 3; b is 0 or 1; c is 0 or 1; and d is 1 to 4; with the proviso that when c is 0, then a+2b=3 and when b is 1, then a=1 and c=0.

In one or more embodiments, the moisture scavenger is a glycoxysilane moisture scavenger. In particular embodiments, the glycoxysilane moisture scavenger may be defined by the formula:

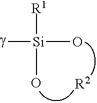

where R¹ is a monovalent organic group, R² is a divalent organic group, and γ is an electron donating group. In particular embodiments, R¹ is a hydrocarbyl group. In other embodiments, R¹ is a hydrocarbyloxy group. In one or more embodiments, γ is a vinyl group.

In one or more embodiments, the monovalent organic groups of the glycoxysilane may be hydrocarbyl groups, which include, but not limited to, alkyl, cycloalkyl, alkenyl, cycloalkenyl, aryl, allyl, aralkyl, alkaryl, or alkynyl groups. Hydrocarbyl groups also include substituted hydrocarbyl groups, which refer to hydrocarbyl groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkyl, cycloalkenyl, and aryl groups are non-heterocyclic groups. In these or other embodiments, the substituents forming substituted hydrocarbyl groups are non-heterocyclic groups.

In one or more embodiments, the moisture scavenger may be 3 A Sieves from UOP, which is a zeolite having 3 Angstrom pores capable of trapping.

In one or more embodiments, the monovalent organic groups of the glycoxysilane may be hydrocarbyloxy groups which include, but are not limited to, alkoxy, cycloalkoxy, substituted cycloalkoxy, alkenyloxy, cycloalkenyloxy, substituted cycloalkenyloxy, aryloxy, allyloxy, substituted aryloxy, aralkyloxy, alkaryloxy, or alkynyloxy groups. Substituted hydrocarbyloxy groups include hydrocarbyloxy groups in which one or more hydrogen atoms attached to a carbon atom have been replaced by a substituent such as an alkyl group. In one or more embodiments, the hydrocarbyloxy groups may include from one, or the appropriate minimum number of carbon atoms to form the group, to 20 carbon atoms. The hydrocarbyloxy groups may contain heteroatoms such as, but not limited to nitrogen, boron, oxygen, silicon, sulfur, and phosphorus atoms.

In one or more embodiments, the divalent organic groups of the glycoxysilane may include hydrocarbylene groups such as, but not limited to, alkylene, cycloalkylene, alkenylene, cycloalkenylene, alkynylene, cycloalkynylene, or arylene groups. Hydrocarbylene groups include substituted hydrocarbylene groups, which refer to hydrocarbylene groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkylene, cycloalkenylene, and arylene groups are non-heterocyclic groups. In these or other embodiments, the substituents forming substituted hydrocarbylene groups are non-heterocyclic groups.

Specific examples of glycoxysilane compounds include vinyl, methyl, 2-methyl-1,3-propanedioxy silane, which may also be referred to as 2,5-dimethyl-2-vinyl[1,2,3]dioxasilinane. These moisture scavengers are available under the tradename Y-15866 (Momentive).

### Adhesion Promoter

As indicated above, the moisture-curable coating compositions may optionally include an adhesion promoter. In one or more embodiments, the adhesion promoter includes a non-polymeric silicon-containing hydrocarbon compound that has a lower molecular weight than the polymer having a silicon-containing hydrolysable group (i.e., the silane-terminate polymer). Also, the adhesion promoter includes at least one hydrolyzable group capable of reacting with a hydrolyzed functional group on the polymer having silicon-containing hydrolyzable terminal groups and includes at least one moiety capable of interacting (i.e., promoting adhesion) with materials that are to be bonded with one another (such as a rubber membrane material). The expression non-polymeric, as used to modify the silicon-containing hydrocarbon compound is meant to exclude polymers and copolymers having at least 10 repeat units or monomeric units, such as urethane prepolymers having silicon-containing hydrolyzable terminal groups but is meant to encompass oligomeric silicon-containing hydrolyzable compounds having fewer than 10 repeat units or monomers, and which are useful for promoting adhesion between a substrate and a cured adhesive composition.

Suitable adhesion promoters include those having an alkoxysilyl, a ketoximesilyl, or an alkenoxysilyl group as the hydrolyzable group, and exemplary such compositions include vinyltris(2-methoxyethoxy)silane, 3-methacryloxypropyltrimethoxysilane, 2-(3,4-epoxycyclohexyl)ethyl trimethoxysilane, 3-glycidoxypropyltrimethoxysilane, 3-glycidoxypropylmethyldiethoxysilane, N-(2-aminoethyl)3-aminopropyltrimethoxysilane, 3-aminopropyltriethoxysilane, 3-(N-aminomethylbenzylamino)propyltrimethoxysilane, 3-mercaptopropyltrimethoxysilane, 3-aminopropyltris(methylethylketoxime)silane, 3-glycidoxy propyltriisopropenoxysilane, and 3-glycidoxypropylmethyldiisopropenoxysilane. In certain embodiments, the adhesion promoter is 3-aminopropyltriethoxysilane (i.e., 3-(trimethoxysilyl)propylamine).

In one or more embodiments of the invention, the coating composition may include an adhesion promoter that produces a reduced amount of volatile organic compound compared to that produced by conventional silane adhesion promoters. Adhesion promoters that produce a reduced amount of volatile organic compound compared to that produced by conventional silane adhesion promoters may be referred to as low VOC-generating adhesion promoters. Low VOC-generating adhesion promoters are described, for example, in U.S. Publication Nos. 2006/0205907 A1 and 2008/0237537 A1, both of which are incorporated by reference herein.

Examples of low VOC-generating adhesion promoters include silanes of the general formula:

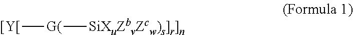

wherein each occurrence of G is independently a polyvalent group derived from the substitution of one or more hydrogen atoms of an alkyl, alkenyl, aryl or aralkyl group, or a group obtained by removal of one or more hydrogen atoms of a heterocarbon, with G containing from about 1 to about 30 carbon atoms; each occurrence of X is independently —Cl, —Br, R¹O—, R¹C(═O)O—, hydroxycarboxylic acids, R¹R² C═NO—, R¹R²NO— or R¹R²N—, —R¹, —(OSiR¹R²)ₜ(OSiR¹R²R³), and —O(R¹⁰CR¹¹)_{f}OH, wherein each occurrence of R¹, R², R³, R¹⁰, and R¹¹ is independently R; each occurrence of Z^{b} is independently selected from the group consisting of (—O—)_{0.5}, [—O(R¹⁰CR¹¹)_{f}O—]_{0.5}, [—NR⁴-L¹-NR⁵—]_{0.5}, [—OC(═O)R¹⁰CR¹¹C(═O)O—]_{0.5} except succinic, maleic or phthalic acid, an alkanolamine or an acetylenic glycol where these groups form bridging bonds between silicon atom centers, wherein each occurrence of R¹⁰ and R¹¹ is independently R and each occurrence of L¹ is independently G; each occurrence of Z^{C} is independently selected from the group consisting of —O(R¹⁰CR¹¹)_{f}O—, —NR⁴-L¹-NR⁵—, —OC(═O) R¹⁰CR¹¹C(═O)O— except succinic, maleic or phthalic acid, an alkanolamine or an acetylenic glycol where these groups form cyclic bonds with a silicon atom center, wherein each occurrence of R¹⁰ and R¹¹ is independently R and each occurrence of L¹ is independently G; each occurrence of R is hydrogen, straight alkyl, cyclic alkyl, branched alkyl, alkenyl, aryl, aralkyl, an ether, polyether, or a group obtained by removal of one or more hydrogen atoms of a heterocarbon; each occurrence of R contains from 1 to about 20 carbon atoms; each occurrence of the subscript f is an integer of from 1 to about 15; each occurrence of n is an integer of from 1 to about 100, with the proviso that when n is greater than 1; v is greater than 0 and all of the valences for Z^{b} have a silicon atom bonded to them; each occurrence of the subscript u is an integer of from 0 to about 3; each occurrence of the subscript v is an integer of from 0 to about 3; each occurrence of the subscript w is an integer of from 0 to about 1, with the proviso that u+v+2w=3; each occurrence of the subscript r is an integer of from 1 to about 6; each occurrence of the subscript t is an integer of from 0 to about 50; each occurrence of the subscript s is an integer of from 1 to about 6; each occurrence of Y is an organofunctional group of valence r; and at least one cyclic and bridging organofunctional silane comprising the cyclic and bridging organofunctional silane composition containing at least one occurrence of Z^{b} or Z^{c}.

In one or more embodiments, the low VOC-generating adhesion promoter may be prepared by reaction of an aminoalkylalkoxysilane with an alkane diol. For example, in one or more embodiments, a silane useful as a low VOC-generating adhesion promoter may be prepared by the transesterification of 3-aminopropyltriethoxysilane with 2-methyl-1,3-propanediol.

### Catalysts

As indicated above, the moisture-curable coating composition may optionally include a catalyst. In one or more embodiments, suitable catalysts may include catalysts for the purpose of promoting the crosslinking the silane-terminated polymer. Without wishing to be bound by any particular theory, it is believed that these catalysts promote the hydrolysis and condensation of organosilicon compounds (i.e., reactions between the terminal groups of the polymer having silicon-containing hydrolyzable terminal groups, and reactions between the optional adhesion promoter when present and the polymer having silicon-containing hydrolyzable terminal groups). In one or more embodiments, hydrolysis of organosilicon compounds may be catalyzed by either acids or bases. Useful basic catalysts that may be employed in the compositions of this invention include alkali metal hydroxides such as potassium hydroxide, silanolates such as lithium silanolate, organic amines, and Lewis bases such as alkali metal carbonates and bicarbonates. Suitable acid catalysts include mineral acids such as sulfuric and phosphoric acids, organic acids such as acetic, propanoic and methane sulfonic acids. Other suitable acid catalysts include Lewis acids such as aluminum chloride, organotin compounds such as dibutyl tin dilaurate and titanium compounds such as the alkyl ortho esters, including tetrabutyl titanate.

### Thixotrope

As indicated above, the compositions of this invention may optionally include a thixotrope, which may also be referred to as thixotropic agent. In one or more embodiments, suitable thixotropic agents may include, but are not limited to, polyvinylpyrrolidone, titanate coupling agents, metal soaps (such as calcium stearate, aluminum stearate, and barium stearate, aluminum distearate, and aluminum tristearate), copolymers with acidic groups, compounds having ionic groups, fumed silica, colloidal silica, asbestine, organic derivatives of castor oil (such as hydrogenated castor oil derivatives), treated clays, organic bentonite, modified polyester polyols (such as polyoxyethylene-polyoxypropylene block copolymers), aliphatic amides, and polyamides (such as polyamide waxes). Specific examples include polyamide waxes, such as “Crayvallac SLX” available from Arkema, or polymerized castor oils such as Flowtone R from Crayvalley.

### Filler

The compositions of this invention may optionally include a filler. In one or more embodiments, the coating compositions include a filler. In particular embodiments, the filler is a mineral filler. Useful mineral fillers include, but are not limited to, clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, fumed silica, and mixtures thereof.

### Antidegradants

The composition of used in this invention may optionally include an antidegradant. In one or more embodiments, useful anti-degradants include UV-stabilizers, antioxidants, and/or antiozonants. Examples of useful antioxidants include hindered phenols and phosphate esters.

### Tackifying Resin

As indicated above, the coating composition of this invention may optionally include a tackifying resin, which may also be referred to as tackifier, tackifying agent, or tackifier resin. In one or more embodiments, suitable tackifying resins include aliphatic, cycloaliphatic, aromatic, aliphatic-aromatic, aromatic modified alicyclic, and alicyclic hydrocarbon resins and modified versions and hydrogenated derivatives thereof; terpenes (polyterpenes), modified terpenes (e.g., phenolic modified terpene resins), phenolic resins, and mixture thereof. Other useful tackifying agents are disclosed in, e.g., U.S. Pat. No. 6,355,317 incorporated herein by reference.

### Coating Composition—Ingredient Amounts

In one or more embodiments, the moisture-curable coating compositions include greater than 45 wt %, in other embodiments greater than 50%, and in other embodiments greater than 55 wt % silane-terminated polymer, based upon the entire weight of the coating composition. In these or other embodiments, the moisture-curable coating compositions include less than 80%, in other embodiments less than 75%, and in other embodiments less than 70% wt % silane-terminated polymer, based upon the entire weight of the coating composition. In one or more embodiments, the moisture-curable coating compositions include from about 45% to about 80%, in other embodiments from about 50% to about 75%, and in other embodiments from about 55% to about 70% wt % silane-terminate polymer, based upon the entire weight of the coating composition.

In one or more embodiments, the moisture-curable coating compositions include greater than 0.1, in other embodiments greater than 0.5, and in other embodiments greater than 1.0 weight parts adhesion promoter per 100 parts by weight of the silane-terminated polymer component. In these or other embodiments, the moisture-curable coating compositions include less than 10, in other embodiments less than 8, and in other embodiments less than 6 weight parts adhesion promoter per 100 parts by weight of the silane-terminated polymer. In one or more embodiments, the moisture-curable coating compositions include from about 0.1 to about 10, in other embodiments from about 0.5 to about 8, and in other embodiments from about 1.0 to about 6 weight parts adhesion promoter per 100 parts by weight of the silane-terminated adhesion promoter. In one or more embodiments, the coating composition is devoid or substantially devoid of adhesion promoter.

In one or more embodiments, the coating compositions include greater than 15, in other embodiments greater than 25, and in other embodiments greater than 35 weight parts plasticizer per 100 parts by weight of the silane-terminated polymer component. In these or other embodiments, the coating compositions include less than 70, in other embodiments less than 55, and in other embodiments less than 45 weight parts plasticizer per 100 parts by weight of the silane-terminated polymer. In one or more embodiments, the coating compositions include from about 15 to about 70, in other embodiments from about 25 to about 55, and in other embodiments from about 35 to about 45 weight parts plasticizer per 100 parts by weight of the silane-terminated adhesion promoter. In one or more embodiments, the coating composition is devoid or substantially devoid of plasticizer.

In one or more embodiments, the moisture-curable coating compositions include greater than 0.1, in other embodiments greater than 0.5, and in other embodiments greater than 1.0 weight parts moisture scavenger per 100 parts by weight of the silane-terminated polymer component. In these or other embodiments, the moisture-curable coating compositions include less than 10, in other embodiments less than 8, and in other embodiments less than 6 weight parts moisture scavenger per 100 parts by weight of the silane-terminated polymer. In one or more embodiments, the moisture-curable coating compositions include from about 0.1 to about 10, in other embodiments from about 0.5 to about 8, and in other embodiments from about 1.0 to about 6 weight parts moisture scavenger per 100 parts by weight of the silane-terminated adhesion promoter. In one or more embodiments, the coating composition is devoid or substantially devoid of moisture scavenger.

In one or more embodiments, the coating compositions include greater than 0.01, in other embodiments greater than 0.05, and in other embodiments greater than 0.1 weight parts catalyst per 100 parts by weight of the silane-terminated polymer component. In these or other embodiments, the coating compositions include less than 1.0, in other embodiments less than 0.5, and in other embodiments less than 0.3 weight parts catalyst per 100 parts by weight of the silane-terminated polymer. In one or more embodiments, the coating compositions include from about 0.01 to about 1.0, in other embodiments from about 0.05 to about 0.5, and in other embodiments from about 0.1 to about 0.3 weight parts catalyst per 100 parts by weight of the silane-terminated adhesion promoter.

In one or more embodiments, the moisture-curable coating compositions include greater than 0.1 weight parts, in other embodiments greater than 0.5 weight parts, and in other embodiments greater than 1 weight parts filler per 100 parts by weight of the silane-terminated polymer component. In these or other embodiments, the moisture-curable coating compositions include less than 10 weight parts, in other embodiments less than 5 weight parts, in other embodiments less than 3 weight parts, in other embodiments less than 1 weight parts, and in other embodiments less than 0.5 weight parts filler per 100 parts by weight of the silane-terminated polymer component. In one or more embodiments, the moisture-curable coating compositions include from about 0.1 to about 10, in other embodiments from about 0.5 to about 3, and in other embodiments from about 1 to about 2 weight parts filler per 100 parts by weight of the silane-terminated polymer component. In one or more embodiments, the coating composition is devoid or substantially devoid of filler.

In one or more embodiments, the coating compositions include greater than 0.1, in other embodiments greater than 1.0, and in other embodiments greater than 2.0 weight parts thixatrope per 100 parts by weight of the silane-terminated polymer component. In these or other embodiments, the coating compositions include less than 10, in other embodiments less than 3.0, and in other embodiments less than 1.0 weight parts thixatrope per 100 parts by weight of the silane-terminated polymer. In one or more embodiments, the coating compositions include from about 0.1 to about 10, in other embodiments from about 0.5 to about 5, and in other embodiments from about 1.0 to about 2.0 weight parts thixatrope per 100 parts by weight of the silane-terminated adhesion promoter. In one or more embodiments, the coating composition is devoid or substantially devoid of thixatrope.

In one or more embodiments, the coating compositions include greater than 0.1, in other embodiments greater than 1.0, and in other embodiments greater than 2.0 weight parts antidegradant per 100 parts by weight of the silane-terminated polymer component. In these or other embodiments, the coating compositions include less than 10, in other embodiments less than 5.0, and in other embodiments less than 3.0 weight parts antidegradant per 100 parts by weight of the silane-terminated polymer. In one or more embodiments, the coating compositions include from about 0.1 to about 10, in other embodiments from about 0.5 to about 5, and in other embodiments from about 1.0 to about 3.0 weight parts antidegradant per 100 parts by weight of the silane-terminated adhesion promoter. In one or more embodiments, the coating composition is devoid or substantially devoid of antidegradant.

In one or more embodiments, the coating compositions include greater than 0.1, in other embodiments greater than 1.0, and in other embodiments greater than 2.0 weight parts tackifying resin (e.g. hydrocarbon resin) per 100 parts by weight of the silane-terminated polymer component. In these or other embodiments, the coating compositions include less than 10, in other embodiments less than 5.0, and in other embodiments less than 3.0 weight parts tackifying resin per 100 parts by weight of the silane-terminated polymer. In one or more embodiments, the coating compositions include from about 0.1 to about 10, in other embodiments from about 0.5 to about 5, and in other embodiments from about 1.0 to about 3.0 weight parts hydrocarbon resin per 100 parts by weight of the silane-terminated adhesion promoter. In one or more embodiments, the coating composition is devoid or substantially devoid of tackifying resin.

In one or more embodiments, the coating compositions include greater than 0.01, in other embodiments greater than 0.05, and in other embodiments greater than 1.0 weight parts solvent per 100 parts by weight of the silane-terminated polymer component. In these or other embodiments, the coating compositions include less than 1.0, in other embodiments less than 0.5, and in other embodiments less than 0.1 weight parts solvent per 100 parts by weight of the silane-terminated polymer. In one or more embodiments, the coating compositions include from about 0 to about 10, in other embodiments from about 0.01 to about 5, and in other embodiments from about 0.1 to about 3.0 weight parts solvent per 100 parts by weight of the silane-terminated adhesion promoter. In one or more embodiments, the coating composition is devoid or substantially devoid of solvent where substantially devoid refers to that amount or less that would otherwise have an appreciable impact on the invention.

### Characteristics of the Uncured Coating Composition

Aspects of the invention can be described with reference to one or more characteristics of the moisture-curable coating composition (i.e. the characteristics of the uncured coating composition).

In one or more embodiments, the moisture-curable coating compositions is tailored to a desired dynamic and static viscosity. This can be achieved by manipulating several parameters such as, but not limited to, the molecular weight of the polymers, the amount of filler, and the use of thixotropic agents.

In one or more embodiments, the moisture-curable coating compositions are characterized by a Brookfield Viscosity, which can be determined by ASTM D789 or D4878 using a #2 spindle at 20 r.p.m. at 23.5° C. and 50% relative humidity. In one or more embodiments, the Brookfield Viscosity (#2 spindle at 20 r.p.m.) of the moisture-curable coating compositions is greater than 300, in other embodiments greater than 400, in other embodiments greater than 500, in other embodiments greater than 600, and in other embodiments greater than 700 centipoise. In these or other embodiments, the of the Brookfield Viscosity (#2 spindle at 20 r.p.m.) of the moisture-curable coating compositions is less than 2500, in other embodiments less than 1500, and in other embodiments less than 1000, in other embodiments less than 900, and in other embodiments less than 800, in other embodiments less than 700, and in other embodiments less than 600 centipoise. In one or more embodiments, the Brookfield Viscosity (#2 spindle at 20 r.p.m.) of the moisture-curable coating compositions is from about 300 to about 2500, in other embodiments from about 400 to about 1500, and in other embodiments from about 400 to about 1000 centipoise, in other embodiments from about 600 to about 900 centipoise, and in other embodiments from about 700 to about 750 centipoise.

In one or more embodiments, the uncured coating compositions are characterized by a tack free time, which can be determined by ASTM C 679 at 20° C. and 50% relative humidity. In one or more embodiments, the tack free time (ASTM C679) of the uncured coating compositions is greater than 1, in other embodiments greater than 2, and in other embodiments greater than 3 minutes. In these or other embodiments, the tack free time of the uncured coating compositions is less than 1 hour, in other embodiments less than 40 minutes, in other embodiments less than 20, in other embodiments less than 15, and in other embodiments less than 10 minutes. In one or more embodiments, the tack free time of the uncured coating compositions is from about 1 to about 20, in other embodiments from about 2 to about 15, and in other embodiments from about 3 to about 10 minutes.

In one or more embodiments, the uncured coating compositions are characterized by minimal shrinking during the curing process. As the skilled person will appreciate, shrinkage can be quantified by the percent volume change in the composition from the time of application to the time of removal of substantially all of the solvent. In one or more embodiments, the percent shrinkage of the uncured coating compositions employed in this invention is less than 10 volume %, in other embodiments less than 5 volume %, and in other embodiments less than 3 volume %, and in other embodiments less than 1 volume %.

In one or more embodiments, the uncured coating compositions are characterized by a reduced substrate swell, particularly to EPDM membrane, at 20° C. and 50% relative humidity. In one or more embodiments, the uncured coating compositions cause an EDPM membrane to swell, after 24 hours of contact time, less than 2%, in other embodiments less than 1%, and in other embodiments less than 0.5%.

In one or more embodiments, the uncured coating compositions are characterized by a relatively low VOC release during the curing process. In one or more embodiments, the uncured coating compositions release, up until complete cure, less than 25, in other embodiments less than 20, and in other embodiments less than 15 grams of VOC/liter of curable sealant composition.

In one or more embodiments, the uncured coating composition includes greater than 95 wt %, in other embodiments greater than 98 wt %, and in other embodiments greater than 99 wt % solids. In particular embodiments, the uncured coating composition is 100% solids composition (i.e., it is solvent free).

### Characteristics of Final Product

In one or more embodiments, the cured membrane created by the practice of the present invention includes a cured sheet of ethylene-propylene-diene copolymer rubber (EPDM). Dispersed within the crosslinked network of ethylene-propylene-diene copolymer may be various additives including, but not limited to, filler, oil, wax, antioxidant, antiozonant, flame retardant, and the like. In one or more embodiments, the cured membrane may be a single-layer sheet or a multi-layer sheet. In certain embodiments, the cured membrane may be devoid of fabric reinforcement or it may include a fabric reinforcement positioned between two or more layers of the sheet. As suggested above, the rubber membrane is adapted for use as a roofing membrane, which among other things, refers to a membrane that can provide a weather-proofing protection, and is capable of being secured to a flat or low-sloped roof. In one or more embodiments, the cured membrane may conform to the standards set forth in ASTM-D4637 (Standard Specification for EPDM Sheet Used in Single-Ply Roof Membrane).

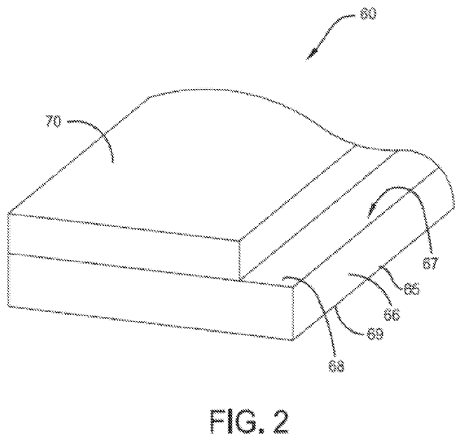

A cured rubber sheet prepared according to the process of the present invention can be described with reference to FIG. 2. Sheet 60, which may also be referred to as composite sheet 60, includes a planar body 65 including cured rubber. Planar body 65 includes first planar surface 67 and second planar surface 69. Disposed on first planar surface 67 is cured coating layer 70. In one or more embodiments, planar body 65 includes a lap region 68 within a portion of first planar surface 67. Lap region 68 can extend laterally along first edge 66 of body 65. In one or more embodiments, cured coating layer 70 is not disposed on lap region 68. In these or other embodiments, a lap region that is substantially free of cured coating layer 70 may also exist on the opposite latter edge of body 65. As described above, coating layer 70 may extend from one lateral edge to the other lateral edge across the entire width of the membrane.

In one or more embodiments, the width of the lap region (e.g., lap region 68) may be from about 2 to about 30 cm, in other embodiments from about 3 to about 20 cm, and in other embodiments from about 4 to about 15 cm.

As described above, the rubber membrane produced according to the process of this invention is substantially free of surface particulate. Substantially free of surface particulate refers to an amount of particulate on the surface of the membrane that is less than an amount that would have an appreciable impact on the subsequent fabrication, modification, or use of the membrane. In one or more embodiments, the rubber membranes of the present invention include less than 20 g/m², in other embodiments less than 10 g/m², in other embodiments less than 5 g/m², in other embodiments less than 1 g/m², in other embodiments less than 0.1 g/m² of surface particulate. In one or more embodiments, surface particulate refers to inorganic dusting agents such as talc or mica. In other embodiments, the surface particulate refers to organic materials, such as cellulose.

### Industrial Applicability

The cured rubber sheet prepared according to the present invention can be used as a roofing membrane to cover flat or low-sloped roofs. The membranes can be attached to the roof surface by using various techniques. In one embodiment, ballast is used. In another embodiment, the membrane is mechanically attached to the roof surface. In another embodiment, a fully-adhered roofing system can be created by the use of a bond adhesive applied during installation. In yet other embodiments, the membrane can carry a fabric backing, such as a fleece backing, and the membrane can be adhered to the roof surface using various adhesives that bind to the fabric backing. In yet other embodiments, the membrane can be fabricated to include a factory-applied adhesive layer, which is a pressure-sensitive adhesive. This membrane assembly typically includes a release paper that is removed at the time of installation and the membrane is adhered, through the pressure-sensitive adhesive, to the roof surface.

In order to demonstrate the practice of the present invention, the following examples have been prepared and tested. The examples should not, however, be viewed as limiting the scope of the invention. The claims will serve to define the invention.

### Examples

### Preparation of Moisture-Curable Coating Composition

A moisture-curable coating composition was prepared by admixing 100 parts by weight of a silyl-terminated polyurethane polymer with about 2.5 parts by weight of a moisture scavenger, 5 parts by weight of an adhesion promoter, about 0.5 parts by weight of a catalyst, and 30 parts by weight of a plasticizer.

### Samples 1-5

Samples 1-5 were prepared by first preparation a vulcanizable rubber composition by using standard membrane recipes as generally described in U.S. Publication No. 2006/0280892 and U.S. Pat. Nos. 5,700,538 and 5,468,550 by using laboratory-scale mixing equipment. The composition notably included a white paraffinic oil. The composition was formed into a plurality of green rubber test sheets having a width of about 15 cm, a length of about 15 cm, and a thickness of about 1500 micrometers.

The moisture-curable coating composition prepared as described above was applied to a planar surface of the test membrane sheets by using rolling techniques. The thickness of the coating layer was about 185 micrometers based upon a coating rate of about 220 square feet per gallon and about 92 micrometers based upon a coating rate of about 440 square feet per gallon, which coverage rates are identified in Table I. The coating composition was allowed to cure for about one hour at 50% relative humidity at about 22° C., and then test samples were prepared by overlapping portions of two samples with a coating composition disposed between the membranes. As provided in Table I, in one set of experiments, the coating composition was applied to both of the contact surfaces. In another set of experiments, the coating composition was applied to only one contact surface. The test sample was then placed in a press and subjected to curing conditions that served to cure the green rubber membranes. Following cure, the test samples were placed into an Instron subjected to peel testing that was conducted generally in accordance with ASTM PSTC 101 (RT). Table I provides the results of peel tests.

TABLE I

| Sample | 1 | 2 | 3 | 4 | 5 |
|---|---|---|---|---|---|
| Number of Contact | One | Two | One | Two | na |
| Surfaces Coated | | | | | |
| Coverage Rate | 220 | 220 | 440 | 440 | na |
| (sq. ft./gal.) | | | | | |
| Avg. Load per inch | 1.05 | 1.07 | 1.52 | 3.62 | 8.78 |
| (lbf/in) | | | | | |
| Standard Deviation | 0.155 | 0.205 | 0.127 | 0.367 | 1.2 |
| Max Load per inch | 2.09 | 2.91 | 5.42 | 5.49 | N/A |
| (lbf/in) | | | | | |
| Standard Deviation | 0.72 | 0.879 | 0.79 | 0.805 | N/A |

### Samples 6-10

Samples 6-10 were prepared by using the same moisture-curable composition and procedures as provided in Samples 1-5, except the vulcanizable rubber formulation was changed One notable change included the use of a conventional paraffinic oil in lieu of a white paraffinic oil Testing was otherwise conducted in the same fashion as Samples 1-5, and the results of the testing are provided in Table II.

TABLE II

| Sample | 6 | 7 | 8 | 9 | 10 |
|---|---|---|---|---|---|
| Number of Contact | One | Two | One | Two | na |
| Surfaces Coated | | | | | |
| Coverage Rate | 220 | 220 | 440 | 440 | na |
| (sq. ft./gal.) | | | | | |
| Standard Deviation | 0.389 | 0.161 | 0.308 | 0.199 | 1.2 |
| Max Load per inch | 4.25 | 2.11 | 4.51 | 3.21 | N/A |
| (lbf/in) | | | | | |
| Standard Deviation | 0.45 | 0.811 | 0.472 | 0.393 | N/A |

Various modifications and alterations that do not depart from the scope and spirit of this invention will become apparent to those skilled in the art. This invention is not to be duly limited to the illustrative embodiments set forth herein.

1. A method for making a cured rubber sheet, the method comprising:
i. providing an uncured rubber sheet, where the uncured rubber sheet includes opposing planar surfaces;
ii. applying a curable coating composition to at least one planar surface of the uncured rubber sheet to form at least one layer of curable coating composition, where the curable coating composition includes a polymer with a silicon-containing hydrolyzable terminal group;
iii. subjecting the curable coating composition to curing conditions that cure the coating composition and thereby form at least one cured coating layer on the uncured rubber sheet, wherein the at least one cured coating layer includes a cured residue of the polymer with a silicon-containing hydrolyzable group;
iv. rolling the uncured rubber sheet having at least one cured coating layer onto itself to form a roll; and
v. subjecting the roll to curing conditions that cure the uncured rubber sheet and thereby forms a roll of cured rubber sheet.

2. The method of claim 1, where the uncured rubber is uncured EPDM, and said process produces a cured EPDM roofing membrane.

3. The method of claim 1, further comprising the step of unrolling the roll of cured rubber sheet after said step of subjecting the roll to curing conditions.

4. The method of claim 1, where said step of providing an uncured rubber sheet includes calendering an uncured EPDM composition into a sheet.

5. The method of claim 1, where the uncured rubber sheet has a thickness of from about 30 mil to about 120 mil.

6. The method of claim 1, where said step of applying includes forming at least one curable coating layer having a thickness of from about 80 μm to about 300 μm.

7. The method of claim 1, where the curable coating composition is moisture curable.

8. The method of claim 1, where the polymer with a silicon-containing hydrolyzable terminal group polymer includes a polyether backbone.

9. The method of claim 8, where the polymer with a silicon-containing hydrolyzable terminal group polymer includes a polyurethane backbone.

10. The method of claim 9, where the curable coating composition is characterized by a Brookfield Viscosity (#2 spindle at 20 r.p.m.) of less than 1500 centipoise.

11. The method of claim 1, where the curable coating composition further includes a plasticizer, a moisture scavenger, an adhesion promoter, and a catalyst, and optionally at least one of an antioxidant, a stabilizer, a tackifier, a filler, a plasticizer, a thixotropic compound, and an anti-degradant.

12. (canceled)

13. The method of claim 1, where said step of subjecting the roll to curing conditions includes placing the roll into an autoclave and subjecting the roll to a temperature of at least 130° C.

14. The method of claim 1, where said step of applying the curable coating composition includes applying the curable coating composition to both said opposing planar surfaces of said uncured rubber sheet.

15. The method of claim 1, where the process is devoid of a step of applying a particulate to a planar surface of the sheet prior to said step of subjecting the roll to curing conditions that cure the uncured rubber sheet.

16. A cured rubber membrane sheet comprising:
i. a roofing membrane having first and second planar surfaces, said roofing membrane including cured rubber; and
ii. a cured coating layer disposed on said first planar surface of said roofing membrane, and wherein the cured coating layer includes a cured residue of a polymer with a silicon-containing hydrolyzable terminal group polymer.

17. The cured rubber sheet of claim 16, where the cured rubber includes cured EPDM, where the roofing membrane has a thickness of from about 30 to about 120 mil, and wherein said cured coating layer has a thickness of from about 80 μm to about 300 μm.

18. The cured rubber sheet of claim 16, where the cured coating layer is disposed on substantially all of said first planar surface.

19. The cured rubber sheet of claim 16, where said first planar surface includes a first lap-edge region and wherein said first lap-edge region is substantially free of said cured coating.

20. The cured rubber sheet of claim 19, wherein a second cured coating layer is disposed on said second planar surface of said roofing membrane.

21. The cured rubber sheet of claim 16, further comprising a layer of pressure-sensitive adhesive disposed on said cured coating layer.
